(19) United States
(12) Patent Application Publication
(10) Pub. No.: US 2014/0167160 A1
(43) Pub. Date: Jun. 19, 2014

(54) TFT array substrate

(71) Applicants: Shyh-Feng Chen, Shenzhen (CN); Ming Hung Shih, Shenzhen (CN); Haiying He, Shenzhen (CN)

(72) Inventors: Shyh-Feng Chen, Shenzhen (CN); Ming Hung Shih, Shenzhen (CN); Haiying He, Shenzhen (CN)

(73) Assignee: Shenzhen China Star Optoelectronics Technology Co. Ltd., Guangdong (CN)

(21) Appl. No.: 13/264,577

(22) PCT Filed: Sep. 1, 2011
(86) PCT No.: PCT/CN11/79250

§ 371 Date: Oct. 14, 2011

(30) Foreign Application Priority Data
Aug. 31, 2011 (CN) 201110255437.6

(51) Int. Cl. G02F 1/1335

(52) U.S. Cl. CPC G02F 1/133512
USPC 257/347

(57) ABSTRACT

The present invention discloses a thin film transistor (TFT) array substrate, which includes a plurality of scan lines, data lines, and common electrode lines disposed on a substrate. The scan lines and the data lines cross with each other to define a plurality of pixel regions that have a plurality of TFTs disposed in the crossing regions therebetween. A plurality of pixel electrodes are disposed in the pixel regions. The TFT array substrate further includes a patterned shielding layer which is insulatively disposed below the data lines. The patterned shielding layer of the present invention can shield the back light directly, and the area of the black matrix on the color filter substrate can be reduced so as to increase the aperture ratio.

### FIELD OF THE INVENTION

The present invention relates to a substrate, and especially to a thin film transistor (TFT) array substrate for a liquid crystal display (LCD).

### BACKGROUND OF THE INVENTION

Because the liquid crystals do not radiate light, the liquid crystal display (LCD) needs to utilize a backlight module to serve as a light source. Light from the light source to penetrate the respective layers of the LCD, such as thin film transistors (TFTs), polarizers, color filters (CFs), etc., in actuality, is shown only about ten percent of the original light source brightness. Due to the inadequate brightness being displayed, although raising the backlight brightness also accordingly raises the brightness of the display panel, the power consumption of the backlight module is also increased.

Thus, in order to enhance the brightness of the LCD panel, a light utilization efficiency of the back light has to be increased. In addition to transmittances of optical components and material thereof, an aperture ratio of pixels has to be increased. The aperture ratio is defined as an area ratio of a transparent region (aperture portion) and the pixel, in which the transparent region is the remainder of an area the pixel minus an area of the following: a data line region, a TFT region, a gate region, a storage capacitor region, and a black matrix (BM) region which is located on a CF substrate for shielding a light leakage around a pixel electrode. It can be seen from the foregoing that a smaller area indicates a larger aperture ratio and a higher brightness being achieved.

In addition to reducing the areas, an accuracy of an alignment between the TFT array substrate and the CF substrate also affects the aperture ratio. Conventional alignment method is by aligning the TFT array substrate with the CF substrate through the BM on the CF substrate. However, because a liquid crystal layer is disposed therebetween the CF substrate and the TFT array substrate, the CF substrate and the TFT array substrate are difficult to be aligned, resulting in a decreasing aperture ratio.

### SUMMARY OF THE INVENTION

Accordingly, an objective of the present invention is to provide a TFT array substrate to overcome the drawbacks of the above-mentioned prior art.

To achieve the foregoing objective, according to an aspect of the present invention, a thin film transistor array (TFT) substrate which is provided by the present invention includes a plurality of scan lines, data lines, and common electrode lines, being disposed on a substrate. The scan lines and the data lines cross with each other for defining a plurality of pixel regions that have a plurality of TFTs disposed in the crosses therebetween. A plurality of pixel electrodes are disposed in the pixel regions. The TFT array substrate further includes a patterned shielding layer which is insulatively disposed below the data lines. Specifically, an insulating layer is disposed between the patterned shielding layer and the data lines. The patterned shielding layer is utilized to shield a back light from a bottom of the substrate. For example, the patterned shielding layer is opaque, and the patterned shielding layer is made of metal.

In one preferred embodiment, the data lines and the patterned shielding layer are completely overlapped, and the patterned shielding layer is electrically coupled to the common electrode lines. Specifically, an insulating layer is disposed between the patterned shielding layer and the data lines. Preferably, the patterned shielding layer is made of metal.

In another preferred embodiment, the data lines and the patterned shielding layer are partially overlapped, and the patterned shielding layer is electrically coupled to the common electrode lines. Specifically, an insulating layer is disposed between the patterned shielding layer and the data lines. Preferably, the patterned shielding layer is made of metal.

Preferably, the patterned shielding layer is a plurality of strip structures, and the strip structures are parallel to the data lines.

Compared with the prior art, the patterned shielding layer can shield the back light directly, and the area of the black matrix on the CF substrate can be reduced so as to increase the aperture ratio. In addition, because the patterned shielding layer is electrically coupled to the common electrode lines, a resistance of the common electrode lines becomes larger, which enables a RC value of the common electrode lines close to but less than a response time of the liquid crystals. Accordingly, a loading of the common electrode can be decreased, and the liquid crystals around the patterned shielding layer do not rotate to maintaining a black state without using the BM to shield the back light.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a schematic drawing illustrating a TFT array substrate according to one preferred embodiment of the present invention;

FIG. 2 is a schematic cross-sectional diagram along A-A′ in FIG. 1; and

FIG. 3 is a schematic cross-sectional diagram along A-A′ in FIG. 1 according to another embodiment.

### DETAILED DESCRIPTION OF THE PREFERRED EMBODIMENTS

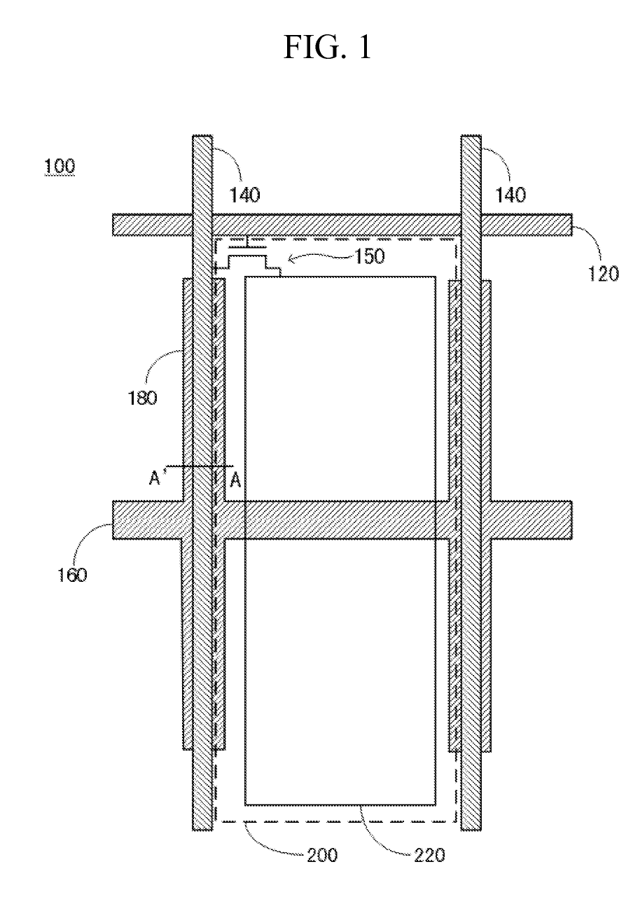

Referring to FIG. 1, FIG. 1 is a schematic drawing illustrating a TFT array substrate according to one preferred embodiment of the present invention. The TFT array substrate includes a substrate 100, a plurality of scan lines 120, data lines 140, common electrode lines 160, and patterned shielding layers 180. In order to explain clearly, the TFT array substrate of FIG. 1 is represented only as a single pixel unit. The scan lines 120 and the data lines 140 cross with each other for defining a plurality of pixel regions 200 which have a plurality of TFTs 150 disposed in the crossing regions therebetween. A plurality of pixel electrodes 220 are disposed in the pixel regions 200. A person skilled in the art is well aware of each of the TFTs 150 herein has a gate, a source, and a drain, so no further detail will be provided herein. The gate, the source, and the drain are respectively coupled to the scan line 120, the data line 140, and the pixel electrode 220.

The common electrode lines 160 are substantially parallel to the scan lines 120 and are alternately disposed with the scan line 120 on the pixel regions 200, and the common electrode lines 160 cross without contacting the data lines 140. More specifically, there is an isolation layer (not shown) disposed between the data lines 140 and the common electrode lines 160 for crossing but do not contact. In order that the pixel electrodes 220 show gray scales according to data signals when the TFTs 150 are not driven by the scan lines 220, storage capacitors are formed with the overlaps between the pixel electrodes 220 and the common electrode lines 160 for storing data signals.

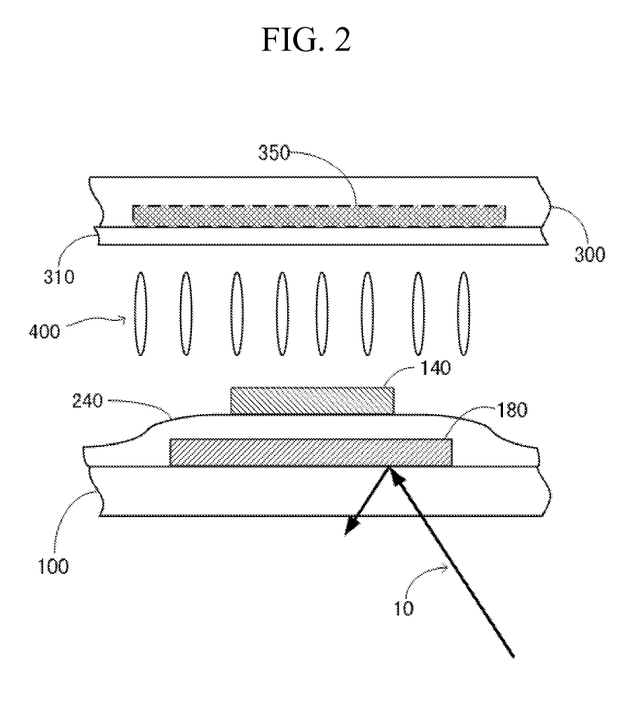

Referring to FIGS. 1 and 2, FIG. 2 is a schematic cross-sectional diagram along A-A′ in FIG. 1. The patterned shielding layer 180 is insulatively disposed below the data lines 140, and the data lines 140 completely overlap the patterned shielding layer 180. Moreover, the patterned shielding layer 180 is electrically coupled to the common electrode lines 160. Similarly, there is an insulating layer 240 disposed between the data lines 140 and the patterned shielding layer 240. Preferably, the patterned shielding layer 180 and the common electrode line 160 are formed in a same photo-mask process. More specifically, the patterned shielding layer 180, the common electrode line 160, and the scan lines 120 are formed in the same photo-mask process. As shown in FIG. 1, the patterned shielding layer 180 is a plurality of strip structures, and the strip structures are parallel to the data lines 140.

Referring to FIG. 2, FIG. 2 further depicts a CF substrate 300, an ITO film 310, and liquid crystals 400 sandwiched between the CF substrate 300 and the substrate 100. In the preferred embodiment, the patterned shielding layer 180 is opaque, for example, it is made of metal. Therefore, the patterned shielding layer 180 can be utilized to shield a backlight 10 from a bottom of the substrate 100. It can be seen from FIG. 2 that the black matrix 350 on the CF substrate 300 can be omitted, hence the aperture ratio is increased. It is worth mentioning that an interval between the patterned shielding layer 180 and the corresponding data line 140 is shorter than an interval between the common electrode line 160 and the corresponding pixel electrode 220.

In accordance with a capacitance equation C=(εA)/d, where ε is the dielectric constant, A is an electrode area, and d is a distance between the electrodes, a capacitance between the patterned shielding layer 180 and the corresponding data line 140 is larger than a capacitance between the common electrode line 160 of an equal size and the corresponding pixel electrode 220. Therefore, the area of the common electrode line 160 on the transparent region can be reduced by disposing the patterned shielding layer 180, hence the aperture ratio is increased. Moreover, because the patterned shielding layer 180 is electrically coupled to the common electrode line 160, a voltage of the patterned shielding layer 180 is a common voltage Vcom. A voltage of the ITO film 310 on the CF substrate 300 is also a common voltage Vcom, so there is essentially no voltage difference between the substrate 100 and the CF substrate 300 around the patterned shielding layer 180. Thus, the liquid crystals 400 do not rotate, and the region is completely black. In addition, because the patterned shielding layer 180 is electrically coupled to the common electrode lines 160, a resistance of the common electrode lines 160 becomes larger, which enables an RC value (time constant) of the common electrode lines 160 close to but less than a response time of the liquid crystals 400.

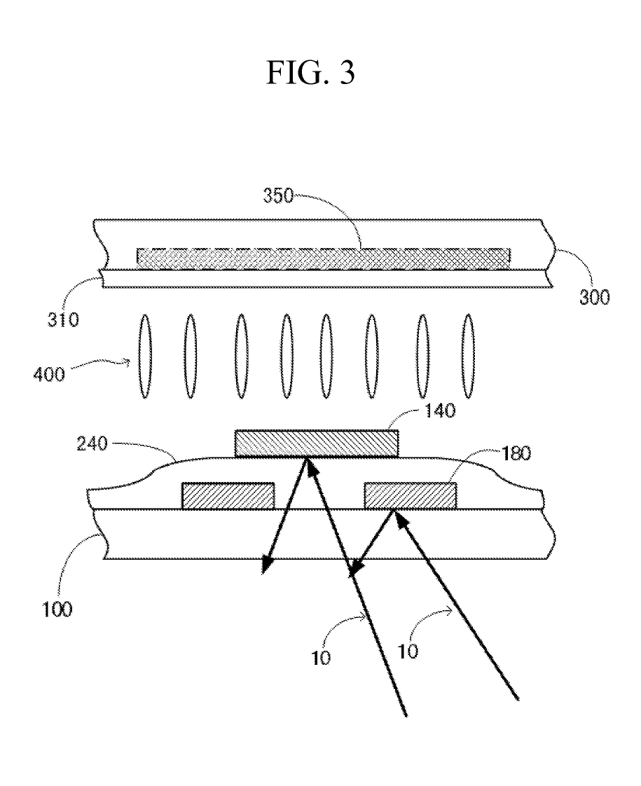

Referring to FIG. 3, FIG. 3 is a schematic cross-sectional diagram along A-A′ in FIG. 1 according to another embodiment. In another embodiment, the data lines 140 partially overlap the patterned shielding layer 180. Specifically, a design of the patterned shielding layer 180 can be subject to a rule of no light leakage under the incident backlight 10, as shown in FIG. 3. It is worth mentioning that an appropriate width of the patterned shielding layer 180 can be calculated by pre-simulating the incident back light 10 for maximizing the aperture ratio.

In summary, the patterned shielding layer 180 can shield the backlight directly, and the area of the black matrix 350 on the CF substrate 300 can be reduced so as to increase the aperture ratio. In addition, because the patterned shielding layer 180 is electrically coupled to the common electrode lines 160, a resistance of the common electrode lines 160 becomes larger, which enables a RC value of the common electrode lines 160 close to but less than a response time of the liquid crystals 400. Accordingly, a loading of the common electrode can be decreased, and the liquid crystals around the patterned shielding layer do not rotate to maintaining a black state without using the black matrix 350 to shield the backlight 10, thereby solving the above-mentioned drawback.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A thin film transistor (TFT) array substrate comprising a plurality of scan lines, data lines, and common electrode lines, disposed on a substrate, the scan lines and the data lines crossing each other for defining a plurality of pixel regions having a plurality of TFTs disposed in the crossing regions therebetween, a plurality of pixel electrodes disposed in the pixel regions, characterized in that: the TFT array substrate further comprises a patterned shielding layer which is insulatively disposed below the data lines.

2. The TFT array substrate according to claim 1, characterized in that the patterned shielding layer is utilized to shield a back light from a bottom of the substrate.

3. The TFT array substrate according to claim 1, characterized in that the data lines and the patterned shielding layer completely overlap each other.

4. The TFT array substrate according to claim 3, characterized in that the patterned shielding layer is electrically coupled to the common electrode lines.

5. The TFT array substrate according to claim 4, characterized in that an insulating layer is disposed between the patterned shielding layer and the data lines.

6. The TFT array substrate according to claim 4, characterized in that the patterned shielding layer is made of metal.

7. The TFT array substrate according to claim 1, characterized in that the data lines and the patterned shielding layer are partially overlapped.

8. The TFT array substrate according to claim 7, characterized in that the patterned shielding layer is electrically coupled to the common electrode lines.

9. The TFT array substrate according to claim 8, characterized in that an insulating layer is disposed between the patterned shielding layer and the data lines.

10. The TFT array substrate according to claim 8, characterized in that the patterned shielding layer is made of metal.

11. The TFT array substrate according to claim 1, characterized in that the patterned shielding layer is a plurality of strip structures.

12. The TFT array substrate according to claim 11, characterized in that the strip structures are parallel to the data lines.

13. The TFT array substrate according to claim 1, characterized in that an insulating layer is disposed between the patterned shielding layer and the data lines.

14. The TFT array substrate according to claim 1, characterized in that the patterned shielding layer is opaque.

15. The TFT array substrate according to claim 14, characterized in that the patterned shielding layer is made of metal.
